(19) United States
(12) Patent Application Publication
(10) Pub. No.: US 2024/0220129 A1
(43) Pub. Date: Jul. 4, 2024

(54) NAND AGING PROTECTION SCHEME

(71) Applicant: Intel Corporation, Santa Clara, CA (US)

(72) Inventors: Sriram Balasubrahmanyam, Folsom, CA (US); Jong Tai Park, Pleasanton, CA (US); Tri Tran, Elk Grove, CA (US); Arti Sharma, Santa Clara, CA (US); Ashish Shukla, San Jose, CA (US)

(21) Appl. No.: 18/147,335

(22) Filed: Dec. 28, 2022

(51) Int. Cl. G06F 3/06

(52) U.S. Cl. CPC G06F 3/0616; G06F 3/0634; G06F 3/0679

(57) ABSTRACT

Systems, apparatuses, and methods may provide for technology for an aging protection scheme for memory structures. For example, such technology determines a completion of a burst cycle operation. Such technology alternates between a first park status applied to even node devices and a second park status applied to odd node devices in response to the determined completion of the burst cycle operation.

### TECHNICAL FIELD

Embodiments generally relate to memory structures. More particularly, embodiments relate to an aging protection scheme for a NAND memory structure.

### BACKGROUND

Three-dimensional (3D) NAND technologies are commonly used to create nonvolatile (NV) storage devices, such as solid state drives (SSDs). Reference to 3D NAND can more specifically refer to NAND flash.

NAND-type flash memory (“NAND memory”) may be organized into multiple cells, with each cell containing one or more bits of data and being accessible through an array of bit lines (columns) and word lines (rows). With 3D NAND processes, the storage array is often created vertical connector pillars connecting a top connection layer to the word lines word lines (WL).

Increased 3D NAND densities are achieved with smaller process geometries and feature spacing. With the increase of number of tiers or word lines in 3D NAND in every generation, the number of contacts is also going up.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a memory/storage device according to an embodiment;

FIG. 2 illustrates an example diagram of uneven aging of stressed and un-stressed devices;

FIG. 3 an example diagram of an even aging protection mechanism according to an embodiment;

FIG. 4 an example diagram of a stress state and a nonstress state utilizing an even aging protection mechanism according to an embodiment;

FIG. 5 illustrates an example of a memory device structure utilizing an even aging protection mechanism for write data input according to an embodiment;

FIG. 6 illustrates an example of a memory device structure utilizing an even aging protection mechanism for read data output according to an embodiment;

FIG. 7 is a flowchart of an example age protection method according to an embodiment;

FIG. 8 is a flowchart of another example age protection method according to an embodiment;

FIG. 9 is an illustration of an example of a semiconductor package apparatus according to an embodiment;

FIG. 10 is a block diagram of an example of a performance-enhanced computing system according to an embodiment; and

FIG. 11 is a flowchart of a further example age protection method according to an embodiment.

### DESCRIPTION OF EMBODIMENTS

As will be descried in greater detail below, systems, apparatuses, and methods are described that provide for technology for an aging protection scheme for memory structures. For example, such technology determines a completion of a burst cycle operation. Such technology alternates between a first park status applied to even node devices and a second park status applied to odd node devices in response to the determined completion of the burst cycle operation.

In operation, some implementations involve an aging protection scheme to enable symmetric PMOS (p-channel metal-oxide-semiconductor) usage (e.g., threshold voltage change by uniform amounts). For example, during normal operation (e.g., without aging protection) only PMOS from alternate inverters are stressed leading to only one edge slowing down. This results in duty cycle deteriorating over an inverter chain. The methodology of aging (e.g., nBTI (negative bias temp instability)) protect scheme, as will be described in greater detail below, is to alternate the “park” status of the internal clock tree (e.g., after every data input (DIN)/data output (DOUT) burst operation completion).

Advantageously, by enabling an aging protection scheme as described in some implementations herein, NAND performance can be guaranteed (e.g., reliably predicted) not only at Time-0 but also at an end-of-life cycle for the customer. As NAND goes into higher I/O (input/output) speeds, nBTI impact to performance is typically higher and an aging protection scheme as described in some implementations herein helps improve margins and enables higher NAND yield and reduces costs. For example, such a scheme ensures that every PMOS in the signal path degrades to the same (or similar) amount. This prevents duty cycle degradation due to pushing out of only high (or low) pulses. Both rising and falling edges are delayed by the same amount, thus maintaining the output duty cycle almost identical to the input duty cycle.

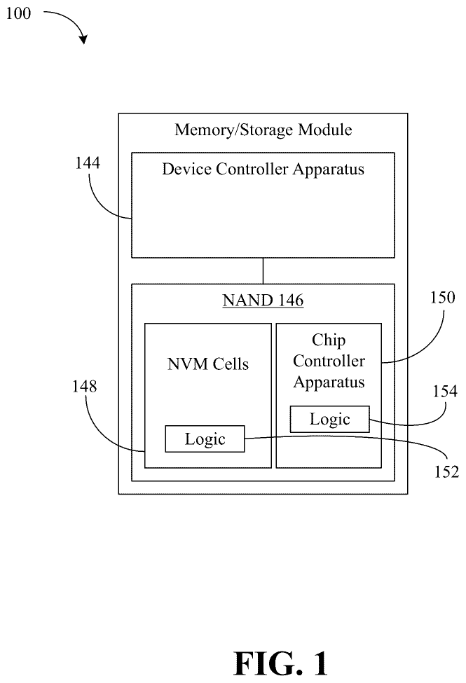

FIG. 1 is a simplified block diagram of an example of a memory/storage device 100 according to an embodiment.

In the illustrated example, a memory/storage device 100 includes a device controller apparatus 144 that is coupled to a NAND 146. The illustrated NAND 146 includes a memory device 148 having a set of NVM cells and logic 152 (e.g., transistor array and other integrated circuit/IC components coupled to one or more substrates containing silicon, sapphire and/or gallium arsenide), and a chip controller apparatus 150 that includes logic 154. The logic 154 may include one or more of configurable or fixed-functionality hardware.

In some implementations, the memory/storage device 100 includes a NAND memory device. For example, such a NAND memory device may include a multi-deck non-volatile memory device. Examples of multi-deck or multi-layer memory architectures include multi-deck memory and 3D NAND memory. Different memory technologies have adopted different terminology. For example, a deck in some memory devices typically refers to a layer of memory cell stacks that can be individually addressed. In contrast, a 3D NAND memory device is typically said to include a NAND array that includes many layers, as opposed to decks. In 3D NAND, a deck may refer to a subset of layers of memory cells (e.g., two decks of X-layers to effectively provide a 2X-layer NAND device). The term “deck” will be used throughout this disclosure to describe a layer, a tier, or a similar portion of a three-dimensional memory.

In some implementations, each of the decks may include an array of memory cells with conductive access lines (e.g., word lines and bit lines). For example, the memory cells may include a material capable of being in two or more stable states to store a logic value. In one example, the memory cells may include a phase change material, a chalcogenide material, the like, or combinations thereof. However, any suitable storage material may be utilized. Accordingly, individual memory cells may include a material capable of being in two or more stable states to store a logic value.

As will be described in greater detail below, in some embodiments, the logic 154 and/or logic 152 implements one or more aspects of technology for an aging protection scheme for memory structures. For example, such technology determines a completion of a burst cycle operation. Such technology alternates between a first park status applied to even node devices and a second park status applied to odd node devices in response to the determined completion of the burst cycle operation.

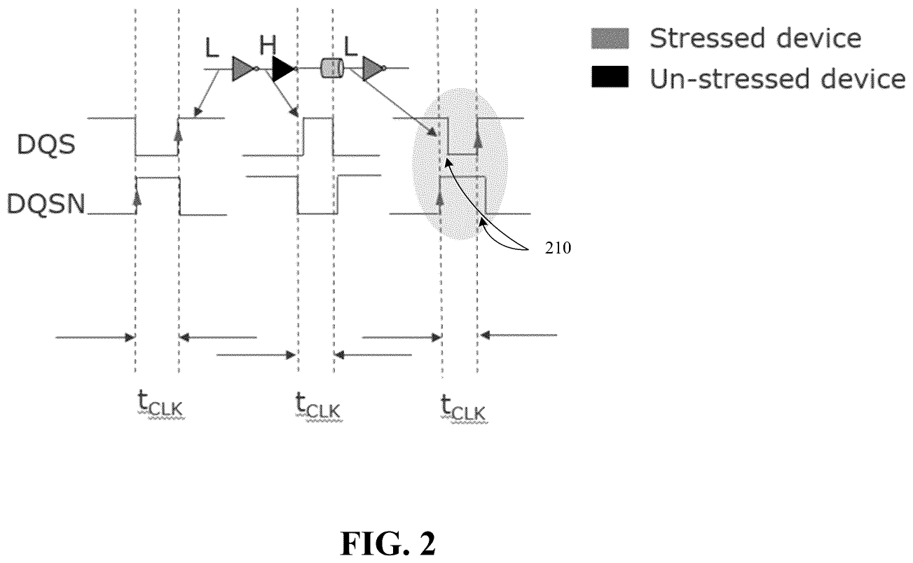

FIG. 2 illustrates an example diagram 200 of uneven aging of stressed and un-stressed devices. As illustrated, nBTI may cause uneven aging on Write (DIN) paths, for example. The AC parameters which are typically impacted by nBTI may be tDIVW, tDIPW, tDSC in DIN path and tDQSQ, tDVWp, tQSH/tQSL, tRC in DOUT path.

For example, device performance is typically degraded by aging factors which are nBTI (negative bias temp instability) and HCl (hot carrier impact). HCl is maximized during DIN (or NAND Write)/DOUT (or NAND Read) burst operations by toggling (e.g., DQ/Read Enable (RE)/DQS toggling). Additionally, nBTI is maximized during parked states (e.g., logic 0 or 1) like NAND active idle or standby modes. A PMOS threshold voltage is increased when input is parked at “ground” due to negative bias of the voltage from gate to source (VGS) which creates stress but if input is parked at the memory device logic power voltage (VCC) then VGS=0 and there is no nBTI stress.

As illustrated, in a Read or Write clock path where there are alternating buffers/inverters, there is often an asymmetric threshold voltage degradation that causes duty-cycle degradation on an x1 clock tree path causing input or output window degradation 210 as shown in FIG. 2.

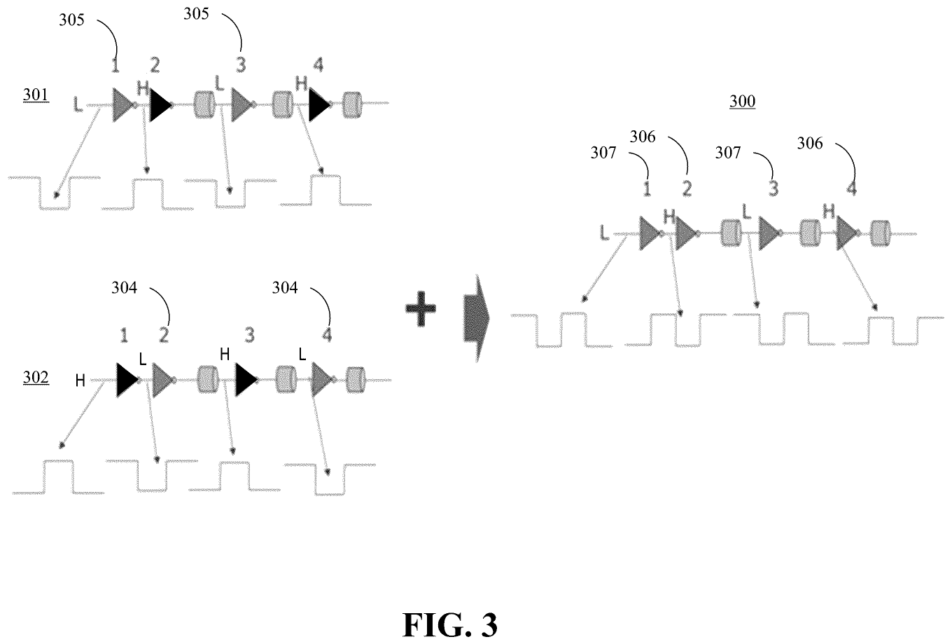

FIG. 3 an example diagram of an even aging protection mechanism 300 according to an embodiment. As illustrated, even aging protection mechanism 300 may ameliorate impacts of nBTI based aging.

For example, nBTI typically happens based on negative VGS for PMOS devices. So, if input parking status is constant (e.g., either parked at “logic 0” or parked at “logic 1”), PMOS Vt degradation will happen for even stage PMOS devices (or odd stage PMOS devices), depending on the parking status. As a result, the signal or clock duty cycle will be degraded (as was illustrated above in FIG. 2). The basic concept of even aging protection mechanism 300 is to alternate a park status of X1 clock (e.g., at every burst operation completion) during the active idle, in order to uniformly stress even PMOS devices 306 and odd PMOS devices 307 on X1 clock domain which will in turn reduce the duty-cycle degradation.

As illustrated, a low parked status 301 illustrates situations where an input signal is parked in “low,” which results in odd stage PMOS devices 305 being degraded unevenly as compared to the even stage PMOS devices 304. Additionally, a duty cycle deterioration occurs due to a resulting change in a rise delay offset as compared to a fall delay offset.

Similarly, a high parked status 302 illustrates situations where an input signal is parked in “high,” which results in even stage PMOS devices 304 being degraded unevenly as compared to the odd stage PMOS devices 305. Additionally, a duty cycle deterioration occurs due to a resulting change in the fall delay offset as compared to the rise delay offset.

Conversely, even aging protection mechanism 300 illustrates the results of utilizing an alternation of input signal between being parked in “low” and “high,” which results in odd stage PMOS devices 307 and even stage PMOS devices 306 having an even degradation. Additionally, a duty cycle deterioration is avoided due to the fall delay offset and the rise delay offset being evenly stress.

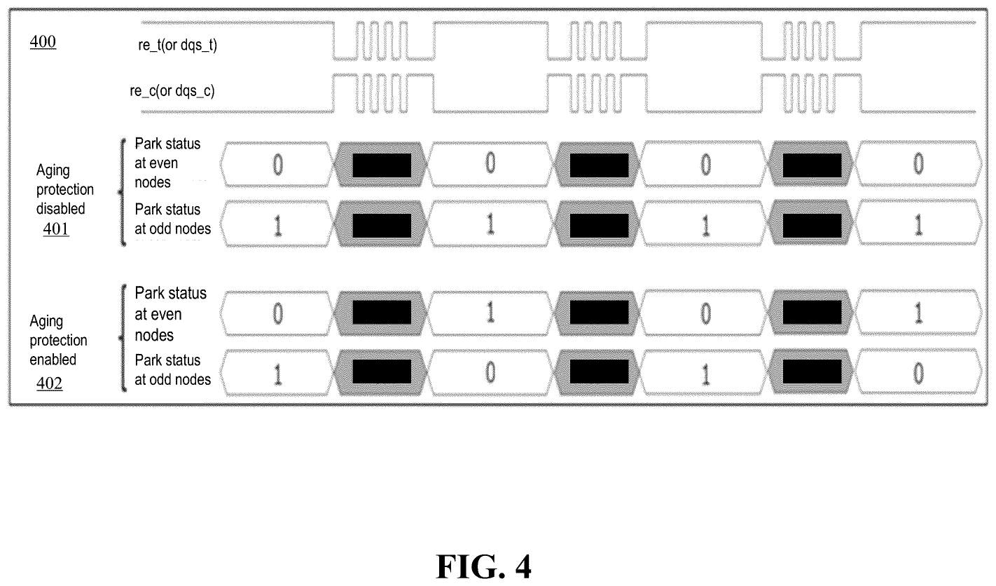

FIG. 4 an example diagram of a stress state and a nonstress state utilizing an even aging protection mechanism 400 according to an embodiment. As illustrated, even aging protection mechanism 400 provides for nBTI aging protection with stress and non-stress state waveform.

In some implementations, even aging protection mechanism 400, when disabled at 401 has a constant internal signal park status (e.g., one-sided), resulting in nBTI and threshold voltage degradation at some specific stage PMOS devices.

In some examples, even aging protection mechanism 400, when enabled at 402 alternates such park status at every burst (e.g., the burst operation illustrated by the toggle cycle operations) by disabling to opposite state after every burst operation so as to degrade the alternate PMOS devices evenly.

In some implementations, even aging protection mechanism 400 can be reset (e.g., reset to an enable default in one mode or reset to a disabled default in another mode) at a standby mode (e.g., when CE # is high greater than 1 us) and can start again from an initialization status once a NAND goes to an active mode.

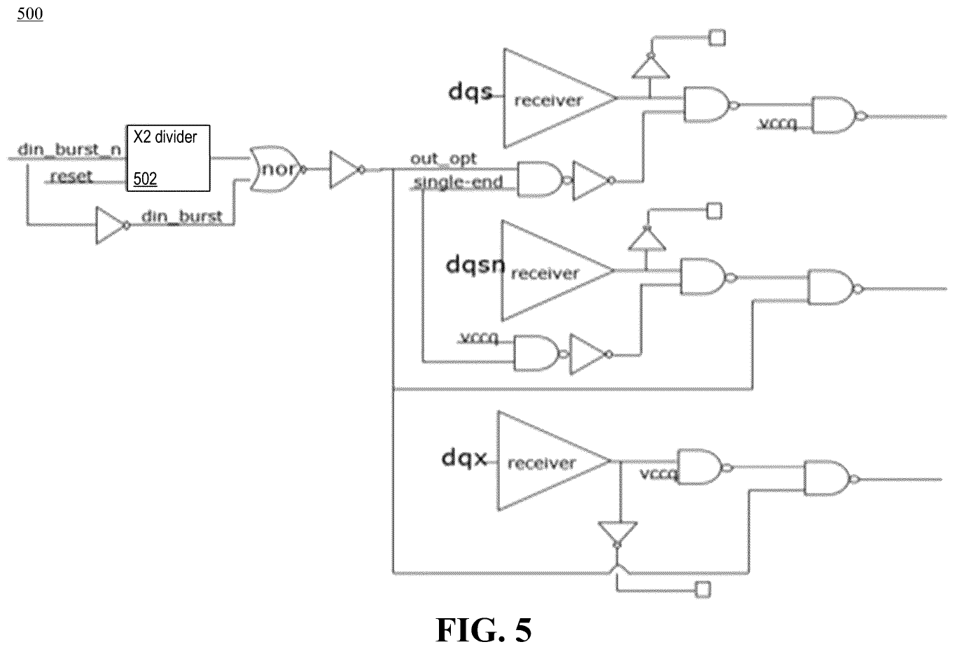

FIG. 5 illustrates an example of a memory device structure 500 utilizing an even aging protection mechanism for write data input according to an embodiment. As illustrated, memory device structure 500 includes a clock divider 502 for write (Data Input) operations. FIG. 5 shows how to alternate park status in DIN operations utilizing an even aging protection mechanism, as described in some examples herein.

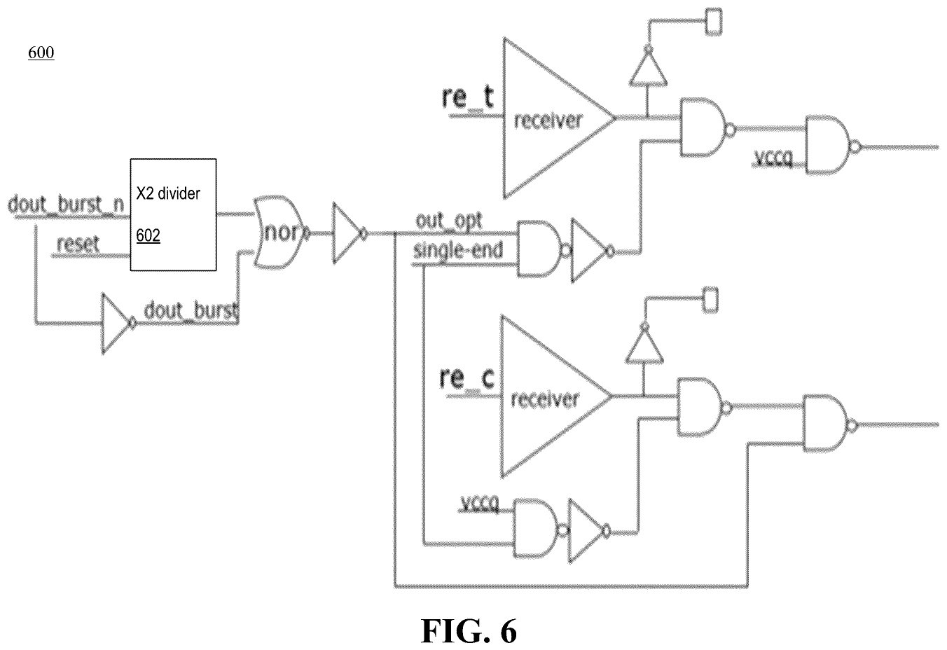

FIG. 6 illustrates an example of a memory device structure 600 utilizing an even aging protection mechanism for read data output according to an embodiment. As illustrated, memory device structure 600 includes a clock divider 602 for read (Data Output) operations. FIG. 6 show how to alternate park status in DOUT operations utilizing an even aging protection mechanism, as described in some examples herein.

For example, RX receiver output for DQS (or re_t) is Low, DQSn (or re_c) is high (e.g., DQ may be high during active idle in some products). In such a situation, all x1 clocks and signals parking status may be the same, which is the worst situation against nBTI for duty cycle management. Accordingly, some of the procedures described herein utilize clock divider 502/602 (e.g., a X2 divider) in which the output is alternated by indicated signal for DIN (or DOUT) burst as like “din_burst” and “dout_burst” and the output of the X2 divider drives DQS(re_t), DQSn(re_c), and DQ RX output to be alternated to be synchronized by din_bust (or dout_burst) disable at the end of burst operations. Then this logic can be utilized to alternate the parking status of all X1 clocks and signals by the X2 clock divider.

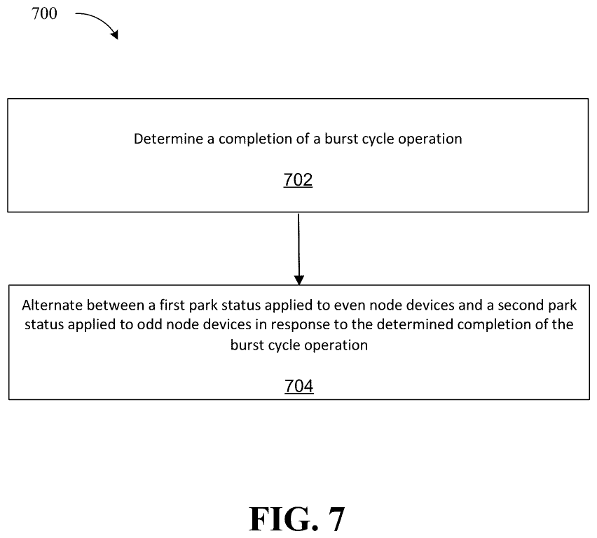

FIG. 7 is a flowchart of an example age protection method 700 according to an embodiment. The method 700 may generally be implemented to form a memory device, such as, for example, memory/storage device 100 (e.g., see FIG. 1).

Illustrated processing block 702 provides for determining a completion of a burst cycle operation.

Illustrated processing block 704 provides for alternating between a first and second park status. For example, alternation may be between a first park status applied to even node devices and a second park status applied to odd node devices and done in response to the determined completion of the burst cycle operation.

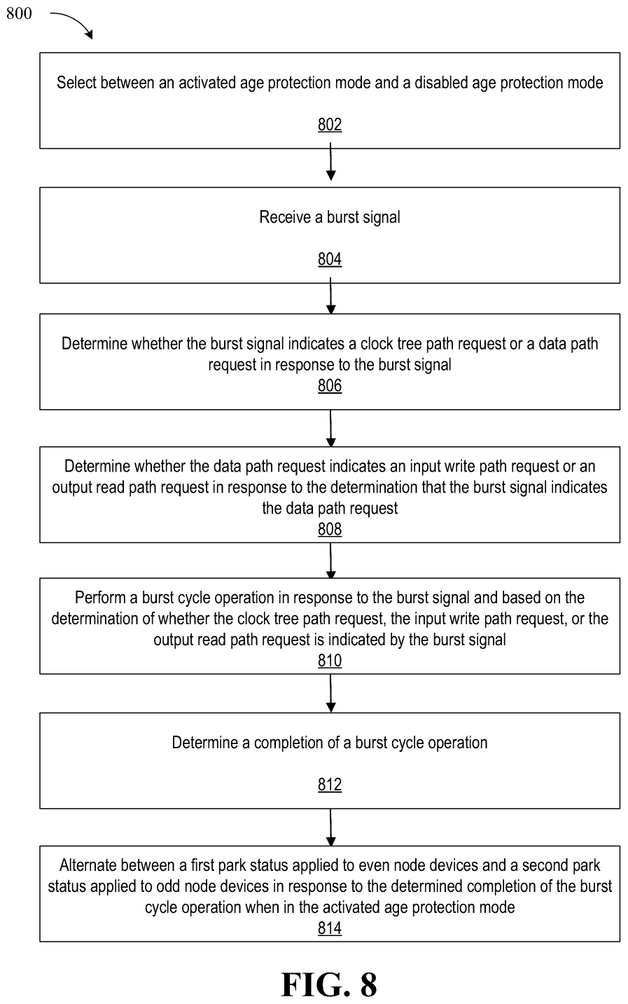

Additional details regarding the various implementations of the method 700 are discussed below with regard to FIG. 8.

FIG. 8 is a flowchart of another example age protection method 800 according to an embodiment. The method 800 may generally be implemented to form a memory device, such as, for example, the memory/storage device 100 (e.g., see FIG. 1).

In an example, the method 800 (as well as method 700 (FIG. 7) may be implemented in computer readable instructions (e.g., software), configurable computer readable instructions (e.g., firmware), fixed-functionality computer readable instructions (e.g., hardware), etc., or any combination thereof.

It will be appreciated that some or all of the operations in method 800 (as well as method 700 (FIG. 7) are described using a “pull” architecture (e.g., polling for new information followed by a corresponding response) may instead be implemented using a “push” architecture (e.g., sending such information when there is new information to report), and vice versa.

Illustrated processing block 802 provides for selecting between an activated age protection mode and a disabled age protection mode. For example, the activated age protection mode is a default mode, and the disabled age protection mode might be automatically selected or selected by a user under certain conditions. Alternatively, the activated age protection mode might be automatically selected or selected by a user under certain conditions.

Illustrated processing block 804 provides for receiving a burst signal.

Illustrated processing block 806 provides for determining whether the burst signal indicates a clock tree path request or a data path request. For example, a determination is made as to whether the burst signal indicates a clock tree path request or a data path request in response to the burst signal.

Illustrated processing block 808 provides for determining whether the data path request indicates an input write path request or an output read path request. For example, a determination is made as to whether the data path request indicates an input write path request or an output read path request in response to the determination that the burst signal indicates the data path request.

Illustrated processing block 810 provides for performing a burst cycle operation. For example, a burst cycle operation is performed in response to the burst signal and based on the determination of whether the clock tree path request, the input write path request, or the output read path request is indicated by the burst signal.

Illustrated processing block 812 provides for determining a completion of a burst cycle operation. For example, the determination of the completion of the burst cycle operation is made in response to the burst signal during an active idle.

In some examples, the operations to determine the completion of the burst cycle operation and to alternate between the first and second park status are performed by a clock divider (e.g., as illustrated in FIGS. 5 and 6).

Illustrated processing block 814 provides for alternating between a first and second park status. For example, alternation may be made between a first park status applied to even node devices and a second park status applied to odd node devices in response to the determined completion of the burst cycle operation when in the activated age protection mode.

In some examples, the even and odd node devices are PMOS devices

In some implementations, the memory die comprises 3D NAND.

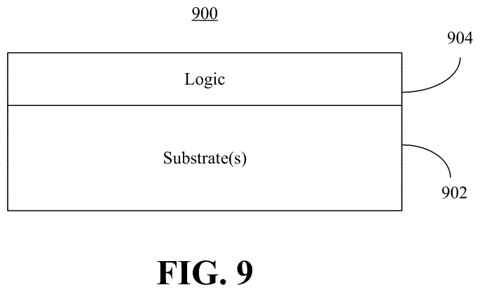

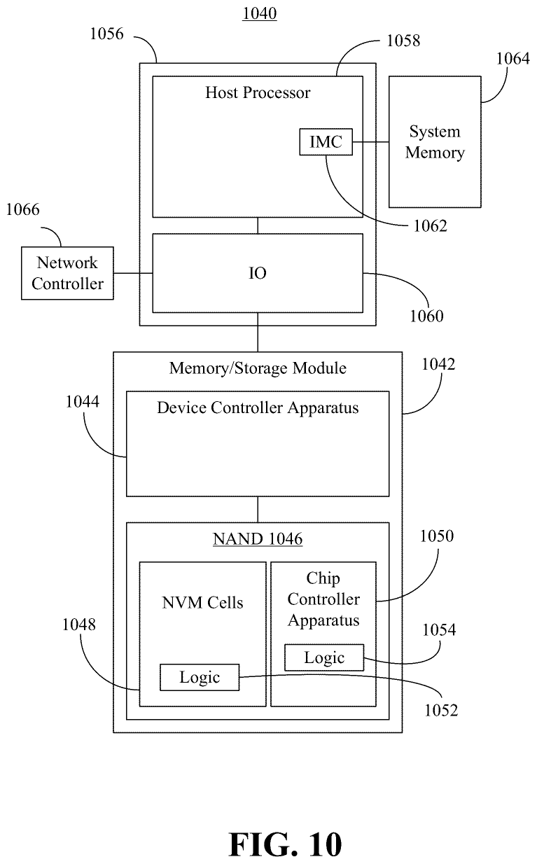

Additional details regarding the various implementations of the method 700 and/or the method 800 are discussed below with regard to FIGS. 9 and 10.

As will be described below, age protection method 1100 may be performed instead of or in combination with implementations of the method 700 and/or the method 800.

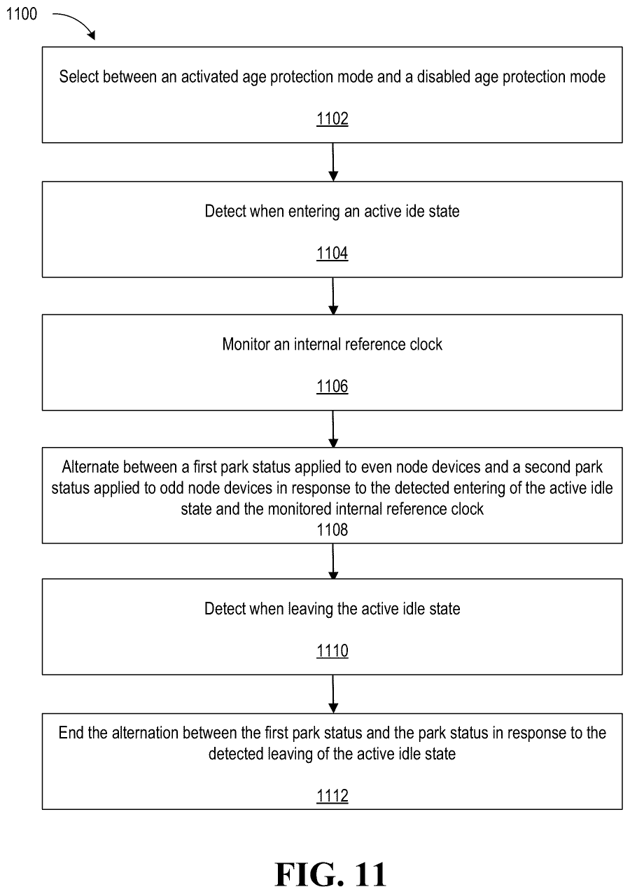

FIG. 11 is a flowchart of a further example age protection method 1100 according to an embodiment. The method 1100 may generally be implemented to form a memory device, such as, for example, the memory/storage device 100 (e.g., see FIG. 1).

In an example, the method 1100 may be implemented in computer readable instructions (e.g., software), configurable computer readable instructions (e.g., firmware), fixed-functionality computer readable instructions (e.g., hardware), etc., or any combination thereof.

It will be appreciated that some or all of the operations in method 1100 are described using a “pull” architecture (e.g., polling for new information followed by a corresponding response) may instead be implemented using a “push” architecture (e.g., sending such information when there is new information to report), and vice versa.

Illustrated processing block 1102 provides for selecting between an activated age protection mode and a disabled age protection mode.

Illustrated processing block 1104 provides for detecting when entering an active idle state. For example, the detected entering of the active idle state is based on detection of a burst signal end.

Illustrated processing block 1106 provides for monitoring an internal reference clock.

In some examples, the monitored internal reference clock is to supply an oscillating signal.

Illustrated processing block 1108 provides for alternating between a first park status applied to even node devices and a second park status applied to odd node devices. For example, such alternating between a first park status applied to even node devices and a second park status applied to odd node devices is done in response to the detected entering of the active idle state and/or the monitored internal reference clock.

Illustrated processing block 1110 provides for detecting when leaving the active idle state. For example, detected leaving of the active idle state is based on detection of a burst signal start.

Illustrated processing block 1112 provides for ending the alternation between the first park status and the park status. For example, ending the alternation between the first park status and the park status is done in response to the detected leaving of the active idle state.

Additional details regarding the various implementations of the method 1100 are discussed below with regard to FIGS. 9 and 10.

FIG. 9 shows a semiconductor apparatus 900 (e.g., chip, die, and/or package). The illustrated apparatus 900 includes one or more substrates 902 (e.g., silicon, sapphire, gallium arsenide) and logic 904 (e.g., transistor array and other integrated circuit/IC components) coupled to the substrate(s) 902. In an example, the logic 904 implements one or more aspects of the method 700 (FIG. 7), the method 800 (FIG. 8), the method 1100 (FIG. 11), and/or a memory/storage device 100 (e.g., see FIG. 1), already discussed.

In one example, the logic 904 includes transistor channel regions that are positioned (e.g., embedded) within the substrate(s) 902. Thus, the interface between the logic 904 and the substrate 902 may not be an abrupt junction. The logic 904 may also be considered to include an epitaxial layer that is grown on an initial wafer of the substrate 902.

Turning now to FIG. 10, a performance-enhanced computing system 1040 is shown. In the illustrated example, a memory/storage module (e.g., a solid state drive (SSD)) 1042 includes a device controller apparatus 1044 that is coupled to a NAND 1046. The illustrated NAND 1046 includes a memory device 1048 having a set of multi-level NVM cells and logic 1052 (e.g., transistor array and other integrated circuit/IC components coupled to one or more substrates containing silicon, sapphire and/or gallium arsenide), and a chip controller apparatus 1050 that includes logic 1054. The logic 1054 may include one or more of configurable or fixed-functionality hardware.

The illustrated system 1040 also includes a system on chip (SoC) 1056 having a host processor 1058 (e.g., central processing unit/CPU) and an input/output (I/O) module 1060. The host processor 1058 may include an integrated memory controller 1062 (IMC) that communicates with system memory 1064 (e.g., RAM dual inline memory modules/DIMMs). The illustrated IO module 1060 is coupled to the SSD 1042 as well as other system components such as a network controller 1066.

In some embodiments, the logic 1054 and/or logic 1052 implements one or more aspects of the method 700 (FIG. 7), the method 800 (FIG. 8), the method 1100 (FIG. 11), and/or the memory/storage device 100 (e.g., see FIG. 1), already discussed already discussed.

### Additional Notes and Examples

Example 1 includes a memory die comprising: one or more substrates and a logic coupled to the one or more substrates. The logic is implemented at least partly in one or more of configurable or fixed-functionality hardware. The logic is to: determine a completion of a burst cycle operation; and alternate between a first park status applied to even node devices and a second park status applied to odd node devices in response to the determined completion of the burst cycle operation.

Example 2 includes the memory die of Example 1, wherein the logic is further to select between an activated age protection mode and a disabled age protection mode.

Example 3 includes the memory die of Example 2, wherein the activated age protection mode is a default mode.

Example 4 includes the memory die of any one of Examples 1 to 3, wherein the logic is further to: receive a burst signal; determine whether the burst signal indicates a clock tree path request or a data path request in response to the burst signal; determine whether the data path request indicates an input write path request or an output read path request in response to the determination that the burst signal indicates the data path request; and perform a burst cycle operation in response to the burst signal and based on the determination of whether the clock tree path request, the input write path request, or the output read path request is indicated by the burst signal.

Example 5 includes the memory die of Example 4, wherein the determination of the completion of the burst cycle operation is made in response to the burst signal during an active idle.

Example 6 includes the memory die of Example 1, wherein the operations to determine the completion of the burst cycle operation and to alternate between the first and second park status are performed by a clock divider.

Example 7 includes the memory die of any one of Examples 1 to 6, wherein the even and odd node devices are PMOS devices.

Example 8 includes the memory die of any one of Examples 1 to 7, wherein the memory die comprises 3D NAND.

Example 9 includes a system comprising: a processor and a memory architecture communicatively coupled to the processor. The memory architecture including logic coupled to one more substrates. The logic is to: monitor an internal reference clock; and alternate between a first park status applied to even node devices and a second park status applied to odd node devices in response to the monitored internal reference clock.

Example 10 includes the system of Example 9, wherein the logic is further to: select between an activated age protection mode and a disabled age protection mode.

Example 11 includes the system of Example 10, wherein the activated age protection mode is a default mode.

Example 12 includes the system of any one of Examples 9 to 11, wherein the logic is further to: detect when entering an active idle state, wherein the detected entering of the active idle state is based on detection of a burst signal end, wherein the monitored internal reference clock is in response to the detected entering of the active idle state, and wherein the alternation between the first park status applied to even node devices and the second park status applied to odd node devices is done in response to the detected entering of the active idle state.

Example 13 includes the system of Example 12, wherein the logic is further to: detect when leaving the active idle state, wherein the detected leaving of the active idle state is based on detection of a burst signal start; and end the alternation between the first park status and the park status in response to the detected leaving of the active idle state.

Example 14 includes the system of any one of Examples 9 to 13, wherein the monitored internal reference clock is to supply an oscillating signal.

Example 15 includes a method comprising: determining a completion of a burst cycle operation; and alternating between a first park status applied to even node devices and a second park status applied to odd node devices in response to the determined completion of the burst cycle operation.

Example 16 includes the method of Example 15, further comprising: selecting between an activated age protection mode and a disabled age protection mode.

Example 17 includes the method of Example 16, wherein the activated age protection mode is a default mode.

Example 18 includes the method of any one of Examples 15 to 17, further comprising: receiving a burst signal; determining whether the burst signal indicates a clock tree path request or a data path request in response to the burst signal; determining whether the data path request indicates an input write path request or an output read path request in response to the determination that the burst signal indicates the data path request; and performing a burst cycle operation in response to the burst signal and based on the determination of whether the clock tree path request, the input write path request, or the output read path request is indicated by the burst signal.

Example 19 includes the method of Example 18, wherein the determination of the completion of the burst cycle operation is made in response to the burst signal during an active idle.

Example 20 includes the method of any one of Examples 15 to 19, wherein the operations to determine the completion of the burst cycle operation and to alternate between the first and second park status are performed by a clock divider.

Example 21 includes a method comprising: monitoring an internal reference clock; and alternating between a first park status applied to even node devices and a second park status applied to odd node devices in response to the monitored internal reference clock.

Example 22 includes the method of Example 21, further comprising: selecting between an activated age protection mode and a disabled age protection mode.

Example 23 includes the method of Example 22, wherein the activated age protection mode is a default mode.

Example 24 includes the method of any one of Examples 21 to 23, further comprising: detecting when entering an active idle state, and wherein the alternation between the first park status applied to even node devices and the second park status applied to odd node devices is done in response to the detected entering of the active idle state.

Example 25 includes the method of Example 24, further comprising: detecting when leaving the active idle state; and ending the alternation between the first park status and the park status in response to the detected leaving of the active idle state.

Example 26 includes the method of any one of Examples 21 to 25, wherein the monitored internal reference clock is to supply an oscillating signal.

Example 27 includes a machine-readable storage comprising machine-readable instructions, which when executed, implement a method or realize an apparatus as claimed in any preceding claim.

Example 28 includes an apparatus comprising means for performing the method of any one of Examples 15 to 26.

Technology described herein therefore provides the capability for even aging protection in some examples. Advantageously, by enabling an aging protection scheme as described in some implementations herein, NAND performance can be guaranteed (e.g., reliably predicted) not only at Time-0 but also at an end-of-life cycle for the customer. As NAND goes into higher IO speeds, nBTI impact to performance is typically higher and an aging protection scheme as described in some implementations herein helps improve margins and enables higher NAND yield and reduces costs. For example, such a scheme ensures that every PMOS in the signal path degrades to the same (or similar) amount. This prevents duty cycle degradation due to pushing out of only high (or low) pulses. Both rising and falling edges are delayed by the same amount, thus maintaining the output duty cycle almost identical to the input duty cycle. Accordingly, such techniques provide improved performance through improved High Input/Output speed and/or decreased power consumption.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A memory die comprising:
one or more substrates; and
a logic coupled to the one or more substrates, where the logic is implemented at least partly in one or more of configurable or fixed-functionality hardware, the logic to:
determine a completion of a burst cycle operation; and
alternate between a first park status applied to even node devices and a second park status applied to odd node devices in response to the determined completion of the burst cycle operation.

2. The memory die of claim 1, wherein the logic is further to:
select between an activated age protection mode and a disabled age protection mode.

3. The memory die of claim 2, wherein the activated age protection mode is a default mode.

4. The memory die of claim 1, wherein the logic is further to:
receive a burst signal;
determine whether the burst signal indicates a clock tree path request or a data path request in response to the burst signal;
determine whether the data path request indicates an input write path request or an output read path request in response to the determination that the burst signal indicates the data path request; and
perform a burst cycle operation in response to the burst signal and based on the determination of whether the clock tree path request, the input write path request, or the output read path request is indicated by the burst signal.

5. The memory die of claim 4, wherein the determination of the completion of the burst cycle operation is made in response to the burst signal during an active idle.

6. The memory die of claim 1, wherein the operations to determine the completion of the burst cycle operation and to alternate between the first and second park status are performed by a clock divider.

7. The memory die of claim 1, wherein the even and odd node devices are PMOS devices.

8. The memory die of claim 1, wherein the memory die comprises 3D NAND.

9. A system comprising:
a processor; and
a memory architecture communicatively coupled to the processor, the memory architecture including logic coupled to one more substrates, wherein the logic is to:
monitor an internal reference clock; and
alternate between a first park status applied to even node devices and a second park status applied to odd node devices in response to the monitored internal reference clock.

10. The system of claim 9, wherein the logic is further to:
select between an activated age protection mode and a disabled age protection mode.

11. The system of claim 10, wherein the activated age protection mode is a default mode.

12. The system of claim 9, wherein the logic is further to:
detect when entering an active idle state, wherein the detected entering of the active idle state is based on detection of a burst signal end, and
wherein the alternation between the first park status applied to even node devices and the second park status applied to odd node devices is done in response to the detected entering of the active idle state.

13. The system of claim 12, wherein the logic is further to:
detect when leaving the active idle state, wherein the detected leaving of the
active idle state is based on detection of a burst signal start; and
end the alternation between the first park status and the park status in response to the detected leaving of the active idle state.

14. The system of claim 9, wherein the monitored internal reference clock is to supply an oscillating signal.

15. A method comprising:
determining a completion of a burst cycle operation; and
alternating between a first park status applied to even node devices and a second park status applied to odd node devices in response to the determined completion of the burst cycle operation.

16. The method of claim 15, further comprising:
selecting between an activated age protection mode and a disabled age protection mode.

17. The method of claim 16, wherein the activated age protection mode is a default mode.

18. The method of claim 15, further comprising:
receiving a burst signal;
determining whether the burst signal indicates a clock tree path request or a data path request in response to the burst signal;
determining whether the data path request indicates an input write path request or an output read path request in response to the determination that the burst signal indicates the data path request; and
performing a burst cycle operation in response to the burst signal and based on the determination of whether the clock tree path request, the input write path request, or the output read path request is indicated by the burst signal.

19. The method of claim 18, wherein the determination of the completion of the burst cycle operation is made in response to the burst signal during an active idle.

20. The method of claim 15, wherein the operations to determine the completion of the burst cycle operation and to alternate between the first and second park status are performed by a clock divider.
